(19) United States
(12) Patent Application Publication
(10) Pub. No.: US 2015/0343454 A1
(43) Pub. Date: Dec. 3, 2015

(54) CHARGED FILTRATION SYSTEM

(71) Applicant: RESTLESS NOGGINS DESIGN, LLC, North Canton, OH (US)

(72) Inventor: Neil R. Tyburk, Canton, OH (US)

(73) Assignee: RESTLESS NOGGINS DESIGN, LLC, North Canton, OH (US)

(21) Appl. No.: 14/294,816

(22) Filed: Jun. 3, 2014

(51) Int. Cl. B03C 3/155; B01D 46/00; B03C 3/019; B03C 3/38

(52) U.S. Cl. CPC B03C 3/155; B03C 3/38; B01D 46/0028; B03C 3/019; B03C 2201/26

(57) ABSTRACT

A charged particle filtration system includes a replaceable charged filtration high air flow filter media, that may have an antimicrobial agent, to reduces costs and increases air purifying efficiency. The system is preferably used in locations that have traceable or even harmful amounts of bacteria, viruses, or germs in the air and have a high occupancy turnover rate, such as hospital rooms. The charged filtration system comprises the high air flow filter media and a conductive electrode array affixed to the high air flow filter media at one of the upstream surface and the downstream surface.

### BACKGROUND OF THE INVENTION

1. Technical Field

The present invention relates generally to filtration systems. More particularly, the present invention relates to charged air particle filtration systems. Specifically, the present invention relates to air filtration through the use of a high air flow filter media having a charged grid array attached thereto.

2. Background Information

It is understood in the fluid filtration field that charged particles can be readily recovered and filtered by a filter medium more effectively than neutral or uncharged particles. When used to filter air, these are known as ionizing air filters. One common ionizing air filter is a precipitator type. The precipitator type is an electronic air filter in which ionizing wires of about 0.005 inches diameter, charged at about 7 Kilovolts. These charged wires are placed between grounded plates to generate a corona. The corona charges dust particles as they are passed through the corona. Further down the airflow path, alternating charged and grounded plates collect the charged particles of dust.

Precipator type filters are advantageous in that they do not require a filter medium to be replaced. However, in this advantage lies a disadvantage of precipitator type air filters. The collector plates are difficult to maintain and require regular cleaning because they collect a large amount of fine dust. Cleaning collector plates may require using very strong detergents. Another disadvantage of the precipitator type filter is that they produce a significant amount of ozone. This occurs because the charging wires are placed near grounded surfaces.

Patents exist for air filters having a conductive electrode attached to the filter media. These filters can mechanically filter air through a pleated fabric and electrically filter air through a precipitator-type filter simultaneously. Namely, U.S. Pat. No. 7,025,806, issued in the name of Coppom et. al. claims a fibrous filter media and a conductive electrode affixed to the fibrous filter media. The term fibrous filter media with respect to the '806 patent refers to a filter made of synthetic or natural fibers, woven or knitted materials, foams, or electret or electrostatically charged materials. The fibrous filter media is synonymous with a conventional pleated air filter ordinarily found and used in a home. A problem often arises with these home air filters because fibrous filter media can have high initial pressure or can block too much airflow as particles become trapped in the filter media. Penultimately, this results in restricted airflow which ultimately causes damage to the equipment containing the filter. To maintain the required airflow, the filters may require frequent filter replacement and the equipment may require frequent maintenance and cleaning. This increases costs for owners utilizing this outdated technology.

Therefore, a need continues to exist for an improved air filtration system. The present invention addresses these and other issues.

### SUMMARY

In accordance with one embodiment, the present invention may provide a charged particle filtration system including a replaceable charged filtration system that reduces costs and increases air purifying efficiency. The system is preferably used in locations that have traceable or even harmful amounts of bacteria, viruses, or germs in the air and have a high occupancy turnover rate, such as hospital rooms. The system allows for a frame to be placed into a hospital room, either permanently or semi-permanently, and a replaceable filter received in the frame to be replaced every time a new patient is admitted into that room. The replaceable filter reduces operating costs for the medical provider while ensuring that the air in the hospital or treatment room is sanitary for each occupying patient.

In one aspect, an embodiment of the invention may provide a charged air filtration system for simultaneously filtering air manually and electrically, and reducing ozone utilizing high air flow technology in a replaceable filter media.

In one aspect, the invention may provide a charged filtration system comprising: a high air flow filter media having an upstream and downstream surface; and a conductive electrode array affixed to the high air flow filter media at one of the upstream and the downstream surface.

In another aspect, the invention may provide a method of operating a charged filtration system comprising the steps of: providing a high air flow filter media having an upstream and downstream surface, the filter media further including a conductive electrode array to one of the upstream and downstream surface; inserting filter media into the downstream end of a frame having a corona wire in a housing, the corona wire electrically connected to a power source; moving air from upstream to downstream around the corona wire and through the filter media; and removing the filter media after the expiration of set period.

In yet another aspect of an embodiment, the invention may provide a charged filtration system comprising: a frame defining a filter retention passage; a high air flow filter media having a conductive electrode affixed to the high air flow filter media; and wherein the high air flow filter media is shaped in a complimentary manner to the filter retention passage and wherein the media is configured to be releasably received in the filter retention passage.

Another embodiment of the invention may provide a charged particle filtration system including a replaceable charged filtration high air flow filter media. The media may have an antimicrobial agent to reduce costs and increases air purifying efficiency. The system is preferably used in locations that have traceable or even harmful amounts of bacteria, viruses, or germs in the air and have a high occupancy turnover rate, such as hospital rooms. The charged filtration system comprises the high air flow filter media and a conductive electrode array affixed to the high air flow filter media at one of the upstream surface and the downstream surface.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims.

FIG. 1 is an assembled perspective view of the charged particle filtration system of the present invention;

FIG. 2 is an exploded perspective view of the present invention;

FIG. 3 is a cross section view of a housing depicting a corona wire of the charged particle filtration system taken along line 3-3 in FIG. 2;

FIG. 4 is a side cross section of the housing depicting the corona wire adjacent the upstream end of the housing;

FIG. 5 is a front view of a high air flow filter having a conductive grid attached thereto of the charged particle filtration system taken along line 4-4 in FIG. 2;

FIG. 6 is an enlarged call-out view the high air flow filter and conductive grid;

FIG. 7 is a cross section taken along line 7-7 in FIG. 6;

FIG. 8 is a schematic view of the charged particle filtration system;

FIG. 9 is an enlarged frontal elevation view of a second embodiment of the present invention;

FIG. 10 is a schematic representation of air flowing through the present invention; and

FIG. 11 is an environmental view of the charged particle filtration system disposed within a hospital room.

Similar numbers refer to similar parts throughout the drawings.

### DETAILED DESCRIPTION

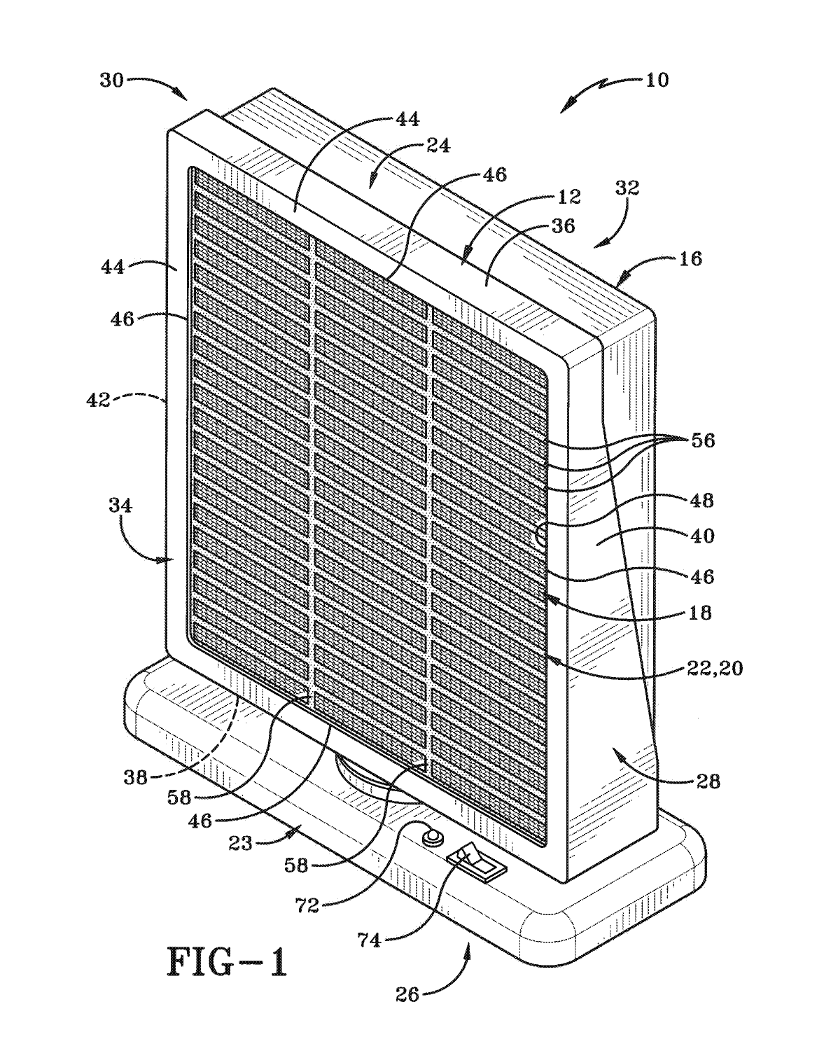

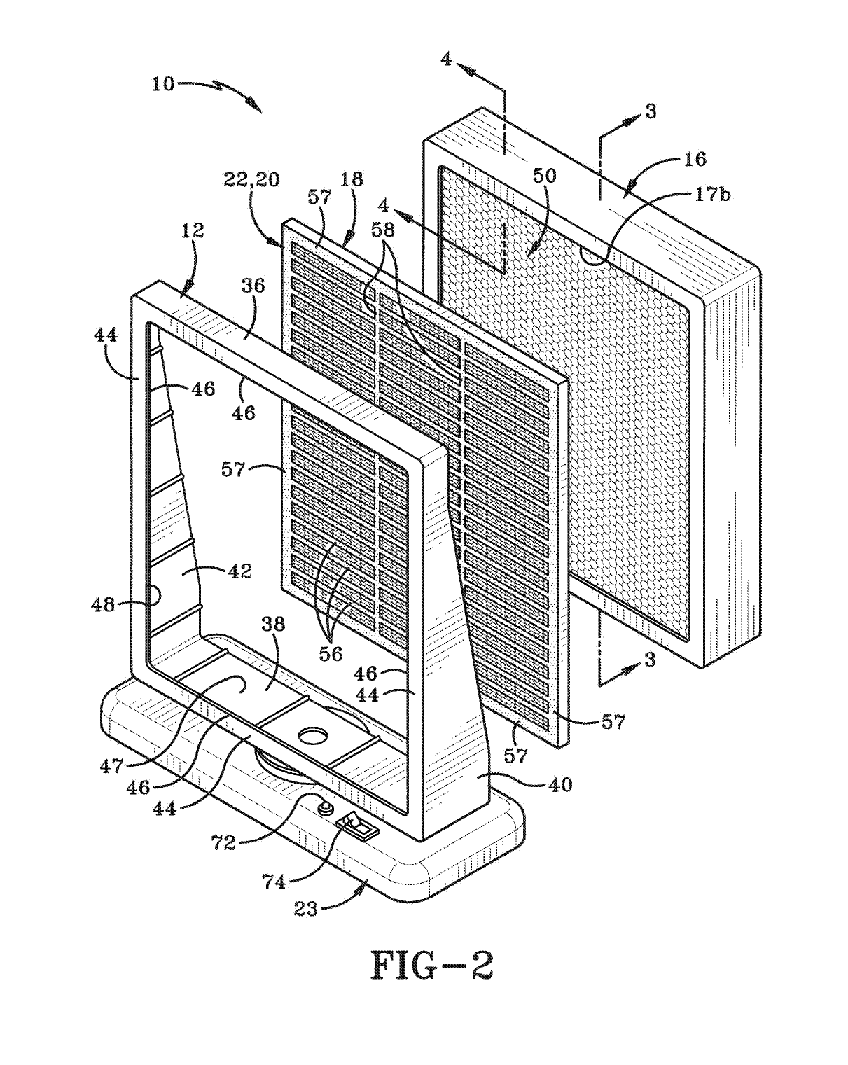

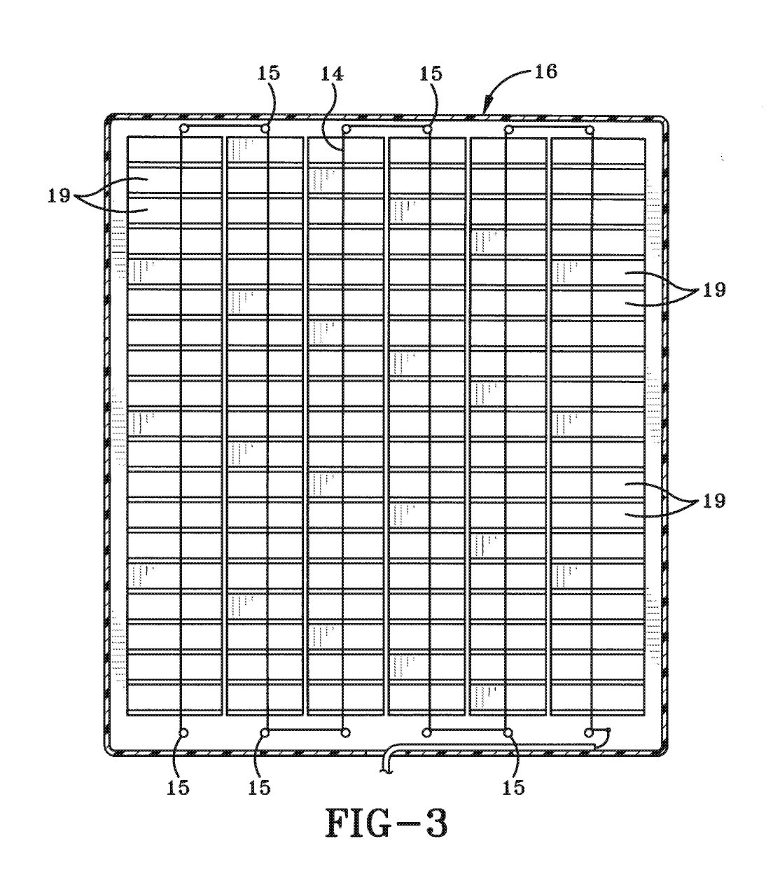

As shown in the FIGS. 1-2, the charged filtration system 10 of the present invention includes a frame 12, a corona wire 14 (FIG. 3) within a housing 16, a filter media 18, a conductive electrode 20 adjacent the filter media and an ozone filter 22 adjacent the conductive electrode 20 on the filter media 18. System 10 includes a top 24 and a bottom 26 that define therebetween a vertical direction. Frame 12 further includes a left side 28 and a right side 30 that define therebetween a lateral direction. Frame 12 further has a front end 32 and a rear end 34 that define therebetween a longitudinal direction. An airflow stream or pathway “F” extends longitudinally from front end 32 to rear end 34.

Frame 12 includes two vertically extending side walls 40, 42 which are spaced apart and preferably parallel to one another. Two horizontally extending and parallel side walls 36, 38 are spaced apart and intersect the two vertically extending side walls 40, 42 to form frame 12. Frame 12 may further include a rearwardly facing first wall 44 extending a short distance inwardly from the rear edges of the longitudinal walls and horizontal walls defining a continuous inner edge 46. Continuous inner edge 46 defines an opening 48 extending from outer surface of first wall 44 to the upstream facing inner surface of the first wall 44. Walls 36, 38, 40, 42 define cavity 47. Cavity 47 receives housing 16 and filter media 18 therein. Frame 12 is configured to receive housing 16 adjacent its upstream end. Frame 12 is further also configured to receive filter media 18 adjacent its downstream end. Frame 12 is connected to a base 23.

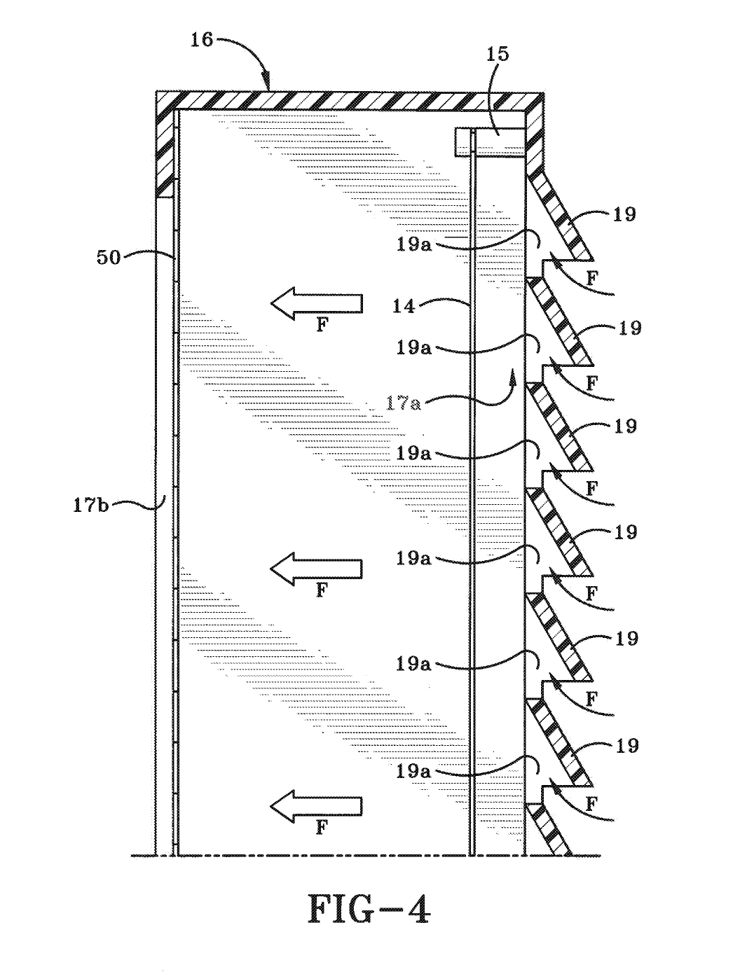

With primary reference to FIGS. 3-4, frame 12 is configured to easily receive housing 16 and filter media 18. Housing 16 is a hollow box design having an intake or entrance opening 17a and an exit opening 17b aligned along the air flow stream F. Housing 16 comprises a grate covering 50 the downstream exit opening 17b and a plurality of horizontally extending slats 19 covering the upstream entrance opening 17a. A slat opening 19a is formed between each respective slat 19. The collective slat openings 19a form a portion of the entrance opening 17a. Grate 50 permits air to pass through while protecting a user from putting hands or objects into or within housing 16. Grate 50 protects the inner components of housing 16 because within the housing 16, tungsten wire or corona wire 14 is bent or formed into a plurality of segments about pins 15. The corona wire 14 extends vertically from the top to the bottom of housing 16. In the shown embodiment, corona wire 14 is formed into six segments that extend vertically and are spaced horizontally equidistant from one another. However, clearly other configurations are possible, for example a different number of segments may exist, or the segments may extend in different directions. Tungsten corona wires 14 are in electrical communication with a high voltage power supply 70, the description of which is detailed fully below.

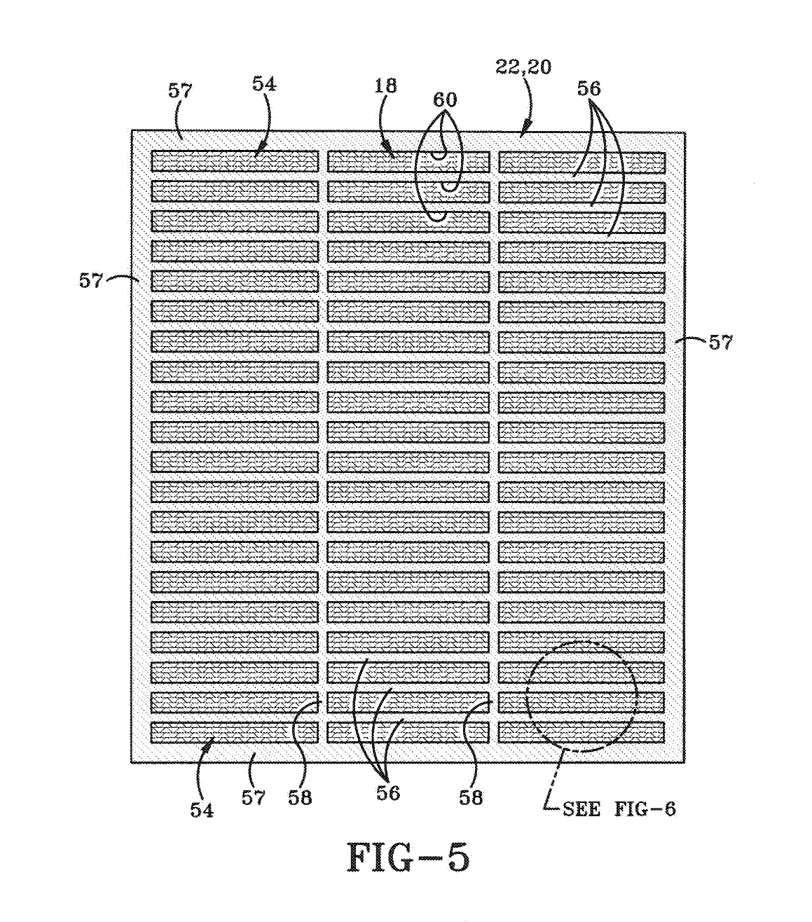

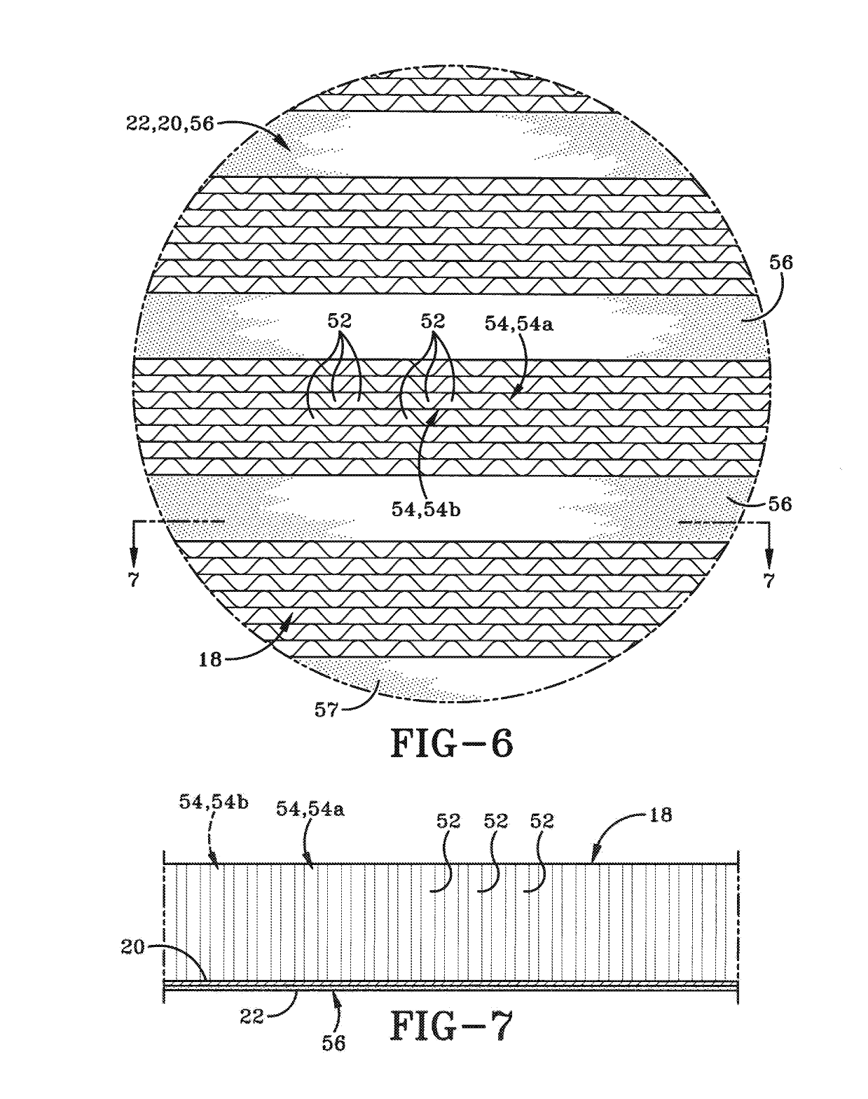

With primary reference to FIGS. 5-7, filter media 18 has a top and bottom, left and right sides, an upstream facing front surface and a downstream facing rear surface. Filter media 18 includes channel walls 54 that define a plurality of channels 52 extending through media 18 from front to back. Channel walls 54 include a corrugated portion 54a and a planar portion 54b. Channels 52 permit air to flow through media from upstream to downstream. Channel walls 54 filter air as air passes through the channel.

In accordance with one aspect of the present invention as described above with reference to filter media 18, preferably media 18 is a high air flow filtration media having an anti-microbial agent. The term high air flow filter media as used herein refers to a filter media that has an initial resistance at a certain air velocity. For example, in a high air flow filter media 18 having a 5 mm channel 52, an air velocity of 1.0 m/s will yield an initial pressure resistance from about 5 to about 7 Pascals (Pa); an air velocity of 2.0 m/s will yield an initial pressure resistance from about 11 Pa to about 14 Pa; and an air velocity of 3.0 m/s will yield an initial pressure resistance from about 16 Pa to about 23 Pa. Another example, in a high air flow filter media 18 having a 20 mm channel 52, an air velocity of 1.0 m/s will yield an initial pressure resistance from about 9 Pa to about 12 Pa; an air velocity of 2.0 m/s will yield an initial pressure resistance from about 17 Pa to about 25 Pa; and an air velocity of 3.0 m/s will yield an initial pressure resistance from about 35 Pa to about 46 Pa.

An exemplary high air flow filter media 18 having an anti-microbial agent is commercially known as “3M™ High Air Flow (HAF) Air Filtration Media with Anti-Microbial Agent” manufactured by the 3M Company of St. Paul, Minn. Filter 18 inhibits the growth of mold and mildew on the filter media. Filter 18, as described above, is an open channel structure made from preferably 100% synthetic media. Filter 18 is frameless and is self-supporting, as the channels support the media 18. The anti-microbial agent is incorporated as an integral part of a microstructured film on the filter media and has little or no effect of filtration efficiency when compared to a standard High Air Flow media (i.e. a high air flow media without an anti-microbial agent). Further, the high air flow filter media 18 of the present invention is different and distinct from a conventional pleated air filter media as known in the art.

Conductive electrode 20 comprises a conductive grid or array that is connected or affixed to filter media 18. Conductive electrode 20 includes a uniform arrangement of rows 56 and columns 58 bound by an edge 57 that define apertures or openings 60 in communication with filter media 18 open channels 52. Openings 60 permit air to flow through openings 60 from upstream to downstream. Conductive electrode 20 is substantially, although not necessarily continuously, connected to filter media 18. Conductive electrode may be formed by depositing conducting paint or colloidal graphite onto filter media 18. Alternatively, electrode 20 may be constructed from conductive metals and physically attached to either the front or rear surface of media 18. Conductive electrode 20 is electrically connected to a high voltage power supply 70 to receive DC voltage. The DC voltage output range of the high voltage power supply 70 is discussed in more detail below.

Ozone is naturally produced by the ionization of air particles from corona wire 14. Ozone filter 22 comprises a layer or film of material to filter or reduce the produced ozone. Ozone filter 22 is closely adjacent conductive electrode 20 and filter media 18 and conductive electrode 20. Preferably, ozone filter 22 is disposed within conductive electrode openings 60 and attached to media 18. Ozone filter 22 preferably contains a form of Magnesium Dioxide, as one in the art would understand Magnesium Dioxide's ozone filtering abilities. However, clearly other chemically based substitute ozone filters are entirely possible. Further, mechanical ozone filters are possible as well. Ozone filter 22 may be formed separately and deposited onto ozone filter 22 on media 18, or can be formed integrally into media 18.

Filter 18 is coupled to frame 12 downstream of housing 16. Filter nestingly and frictionally engages sidewalls of frame 12 to remain in place. The frictional engagement is easily overcome by a human exerted force so the filter 18 may be easily replaced when a new patient enters a hospital room 100 (FIG. 11). Yet, the frictional forces are strong enough to hold the filter in its frictionally engaged nesting relationship with frame 12 as air is moved through filter 18. Housing 16 is preferably positioned with front opening facing upstream and the rear opening facing downstream. Housing 16 is coupled with frame 12 by inserting housing 16 into the downstream end of frame 12. Housing 16 nestingly engages frame 12. Housing 16 remains frictionally engaged with frame 12. While the present invention provides no securing members, such as screw, tape, or adhesive, clearly known methods of securing housing 16 to frame 12 are contemplated.

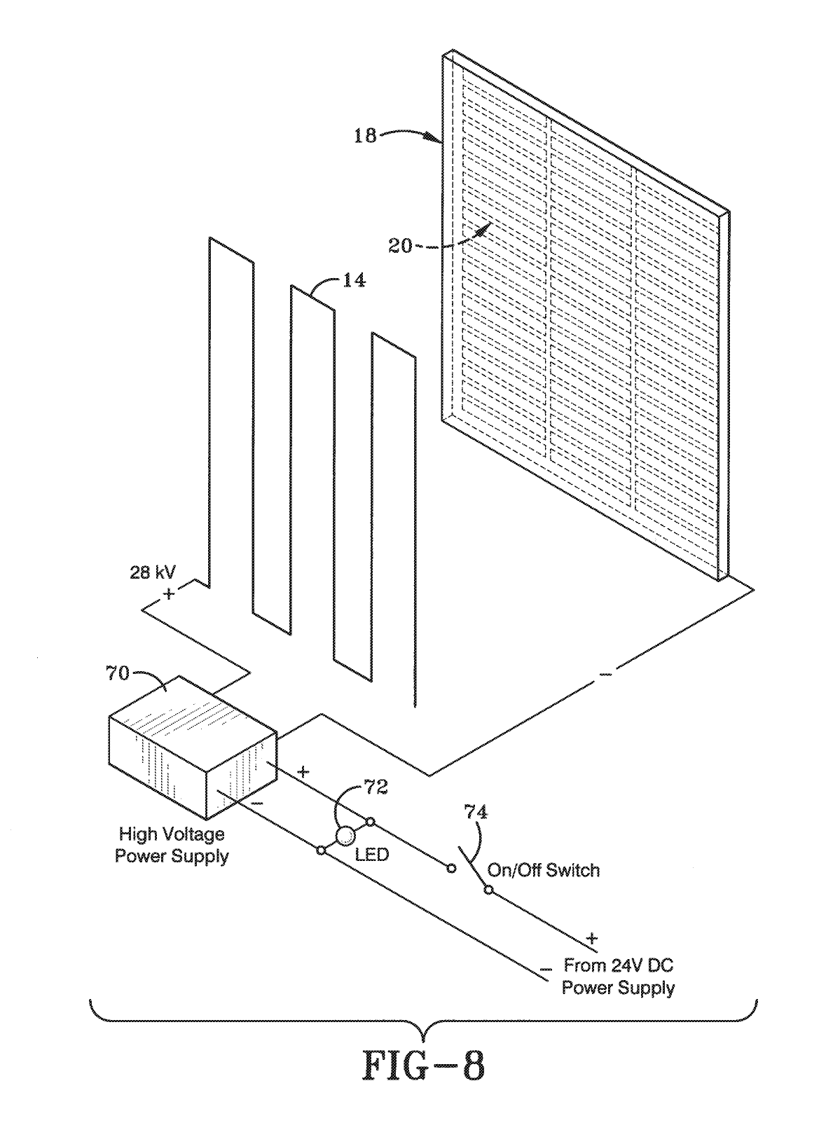

As shown by the schematic of FIG. 8, the electrically conductive electrode array or grid 20 on filter 18 and corona wires 14 in housing 16 are electrically connected to a high voltage power supply 70. Corona wires 14 are electrically connected to the positive output of high voltage power supply 70, giving corona wires a positive charge. Thus, giving the air along flow stream F a positive charge as it passes over positively charged wires 14. Conductive electrode grid 20 is electrically connected to the negative output of high voltage power supply 70. The term “high voltage” with respect to this application means a voltage supply capable of putting out at least 20 kV of power. Preferably, high voltage supply will output 28 kV to power corona wire. While it is contemplated that the high voltage power supply will amplify a 24V direct current input, other input power voltages are entirely possible. A LED indicator 72 is in electrical communication with power supply 70 to indicate to a user, whether or not, apparatus 10 is turned on. Further, a switch 74 is operatively connected to power supply 70 to turn the power on/off.

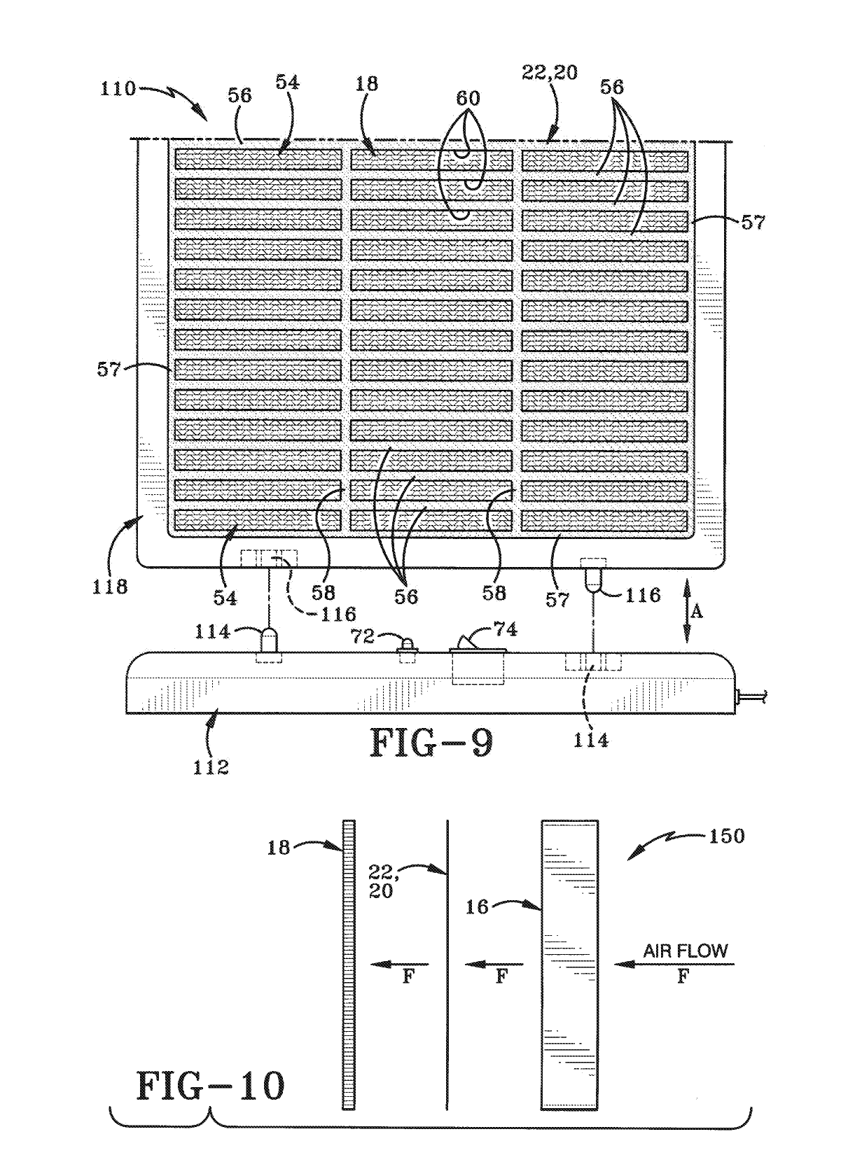

With reference to FIG. 9, a second embodiment of the present invention is depicted generally at 110. The second embodiment 110 includes a base 112, a first set of charging pins 114 located on the base 112, a frame 118, and a second set of charging pins 116 located on the frame 118 complimentary to the first set of charging pins 114. The frame 118 of the second embodiment 110 contains the filter media 18 and electrode 20 similar to the first embodiment 10. The second embodiment allows the frame 118 to be releasably connected in the direction of Arrow A to establish an electrical circuit to charge the corona wires. Frame 118 is releasably secured to the base 112 by a connection point located at where pins 114 meet pins 116.

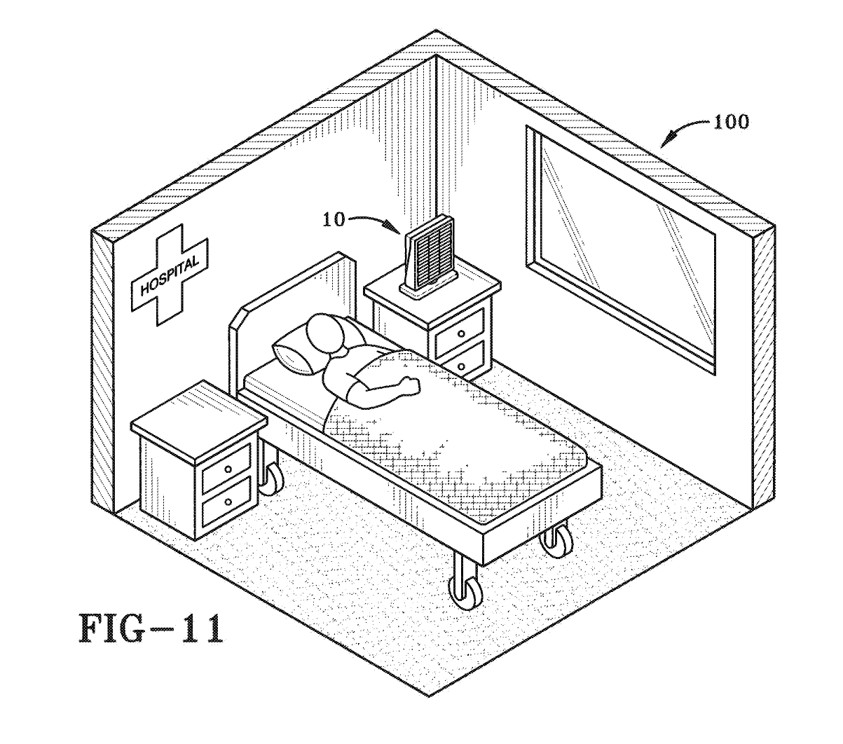

As shown in FIG. 10, a schematic representation of the airflow F moving through the present invention is depicted generally at 150. Air flows in the direction of Arrow F (also shown in FIG. 4), moving first through the charged corona wires 14 (not shown in FIG. 10) within housing 16 and then passing over charged electrode 20, and then flowing through high air flow filter media 18. The schematic of FIG. 10 shows an alternative placement of electrode 20. Electrode 20 may be positioned either upstream of media 18 (FIG. 10) or downstream of media 18 (FIG. 2). Both configurations are contemplated by the present invention.

With reference to FIG. 11, System 10 or 110 is assembled by placing frame 12 into a space having air needing to be sanitized, preferably, a hospital room 100, however other uses where clean air is desirable are clearly possible. In accordance with one embodiment of the present invention as herein described above, the system 10 provides a replaceable charged filtration unit that reduces costs and increases air purifying efficiency. System 10 is preferably used in locations that have traceable or even harmful amounts of bacteria, viruses, or germs in the air and have a high occupancy turnover rate, such as hospital rooms. System 10 allows for frame 16 to be placed into a hospital room, either permanently or semi-permanently, and filter 18 to be replaced every time a new patient is admitted into that room. The replaceable filter 18 reduces operating costs for the medical provider while ensuring that the air in the hospital or treatment room is sanitary for each occupying patient. Alternatively, base 112 may be permanently left in room and the second embodiment frame 118 replaced when a new patient is admitted to the hospital room 100.

In accordance with one aspect of the present invention as described above with reference to filter media 18, a high flow air filter is more advantageous than a conventional pleated fibrous filter. High flow filter media 18 reduces costs for the charged filtration system 10 owner because maintenance time, productivity, and efficiency play an important role in a building's operation. High air flow media 18 with an affixed conductive electrode 20 array electrically and mechanically captures airborne particles or dust, while maintaining necessary airflow through filter system 10. Further, filter 18 is replaceable such that when frame 16 is secured in a room, filter 18 may be easy replaced, preferably when a new patient is admitted into a hospital room 100 (FIG. 11).

In operation, an assembled system 10 air is moved or forced from upstream to downstream along the air flow pathway F (FIG. 4; FIG. 10). The air flowing downstream contains particles that are neutrally charged. Air enters the upstream end housing 16. Air continues to move across and around positively charged corona wires 14. As air and the neutrally charged articles move across a corona field induced by the positively charged corona wires 14, particles are positively charged. The positively charged particles are ions. Corona wires 14 also create ozone during ion production. Any bacteria suspended in the air that contacts the charged corona wire 14 will be electrically shocked and neutralized.

Air containing charged particles is directed to filter 18 which mechanically and electronically capture uncharged particles (mechanically) and charged particles (electrically). Filter 18 is constructed to provide a suitably low resistance to airflow and to prohibit bypass airflow. In the particular examples, filter 18 is a disposable element that will collect particles during system 10 operation which are then disposed when filter assembly is discarded and replaced. Typically, cleaning filter 18 by methods such as vacuuming or washing may restore initial air flow rates; however, other performance metrics may not be restored, depending upon the type of particles encountered during in situ use.

Conductive electrode 20 is connected to one surface of a filter media 18. One non-limiting exemplary material of conductive electrode 20 is metallized BoPET (Biaxially-oriented polyethylene terephthalate), which is known commercially under the trade name of Mylar. As shown in the Figures, electrode 20 is connected to the downstream surface of media 18, however electrode 20 could be connected to the upstream surface or both surfaces of filter media 18. As shown in FIG. 1, conductive electrode is coupled to a system common or ground potential or to a power supply of opposite polarity to the corona wires 14. Preferably conductive electrode 20 makes contact with the downstream surface of the filter media 18 in a grid pattern or array defining through apertures. The apertures defined by the grid spacing not only provide a substantially uniform electric field between conductive electrode 20 and corona wires 14 to provide a uniform particle collection/distribution over the entire surface of the filter media 18, but also allows for the ozone reducing layer (i.e., ozone filter 22) to be uniformly applied to media 18 in the apertures or adjacent the apertures.

By coupling ozone reducing layer to the filter media 18 adjacent the conductive electrode 20 the maximum air filtering and ozone reduction efficiency is reached.

Preferably, high air flow filter media 18 having conductive electrode array 20 is inserted into the downstream end of frame 12 having a corona wire 14 in housing 16. The corona wire 14 electrically connected to the power source and is charged. Air is then moved from upstream to downstream around and over the corona wire 14 and through the filter media 18. Then, once the filter media 18 has finished filtering air, the filter media 18 is removed from frame 12 and can be replaced with a second filter media having similar properties as media 18.

As shown in FIG. 11, media 18 is designed to be replaceable and be used only for a set period. The term set period as used herein refers to a length of time in which the filter 18 is in use; it is contemplated that a set period will equal the length of time a single patient is admitted into a hospital room. Such that, system 10 having filter 18 is inserted into frame 12 to filter the air in the hospital room 100, then when the patient is released from the hospital room, a hospital worker can replace the used filter with a new filter prior to admitting a new patient in the same hospital room 100. A second set period would be a length of time that the new patient would be admitted in the hospital room 100.

While the term hospital room has been used to refer to a location with reference to the set period, clearly other rooms or areas that have a high occupancy rate and have a high desirability of being sterile, such as bathrooms, transportation vehicles (i.e., cars, airplanes, trains, buses, etc.) and their respective stations, as well as personal dwellings would benefit from the advantages disclosed herein.

An exemplary method of operating a charged filtrations system comprises the steps of: providing a high air flow filter media having an upstream and downstream surface, the filter media further including a conductive electrode array to one of the upstream and downstream surface; inserting the filter media into the downstream end of a frame having a corona wire in a housing, the corona wire electrically connected to a power source; moving air from upstream to downstream around the corona wire and through the filter media; and removing the filter media after the expiration of set period.

Additionally, while tungsten wire or corona wire 14 have been identified has being constructed of tungsten or a similar alloy thereof, additional materials, such as stainless steel, may be used in lieu of tungsten. Stainless steel corona wires provided a less expensive alternative to ionize air particles flowing past wire 14.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

1. A charged filtration system comprising:
a reusable frame defining a temporary filter retention passage;
a high air flow filter media having a conductive electrode affixed to the high air flow filter media; and
wherein the high air flow filter media is shaped in a complimentary manner to the filter retention passage of the frame and wherein the media is configured to be releasably received in the filter retention passage.

2. The charged filtration system of claim 1, further comprising:
a reusable air flow charging unit, the unit including at least one corona inducing charged wire to ionize a stream of air passing through the charging unit; and
wherein the charging unit is shaped in a complimentary manner to the filter retention passage of the frame and wherein the charging unit is configured to be releasably received in the filter retention passage upstream of the high air flow filter media.

3. The charged filtration system of claim 2, wherein the conductive electrode comprises metallized biaxially-oriented polyethylene terephthalate; and
wherein the corona inducing wire comprises one of a tungsten alloy and a stainless steel alloy.

4. A charged filtration system comprising:
a high air flow filter media having an upstream and downstream surface; and
a conductive electrode array affixed to the high air flow filter media at one of the upstream surface and the downstream surface.

5. The system of claim 4, further comprising an ozone filter affixed to the high air flow filter.

6. The system of claim 5, wherein the ozone filter comprises magnesium dioxide, and wherein the conductive electrode comprises metallized biaxially-oriented polyethylene terephthalate.

7. The system of claim 5, wherein the conductive electrode array defines a plurality of through apertures; and
wherein the ozone filter is disposed adjacent the apertures.

8. The system of claim 4, further comprising a corona wire positioned upstream of the high air flow filter to charge air particles flowing from upstream to downstream.

9. The system of claim 4, further comprising:
an ozone filter comprising magnesium dioxide, attached to the high air flow filter media;
a corona wire housed within a wire housing and electrically connected to a power source to charge air particles moving from upstream to downstream;
a frame receiving the housing and the filter media, wherein the housing is positioned upstream of the filter media and adapted to be portably placed within a room that requires disinfecting and air filtering.

10. The system of claim 9, in combination with a hospital room, wherein the system is disposed within a hospital room.

11. The combination of claim 10, wherein the high air flow filter media is replaced prior to each time a new patient is admitted into the hospital room

12. The system of claim 4, further comprising:
a corona wire fixedly attached within a wire housing to charge air particles moving from upstream to downstream;
a frame to receive the housing and the filter media, wherein the frame is secured in a location, and the filter media is removably positioned downstream of the corona wire.

13. The system of claim 4, further comprising:
a frame that receives the wire housing and the first high air flow filter media, wherein the first high air flow filter media is removable from the frame;
a second high air flow filter media, separated from the frame, having an upstream and downstream surface having a conductive electrode array affixed to the second high air flow filter media at one of the upstream surface and the downstream surface; and
wherein the first high air flow filter media operates for a set period of time, and wherein when the set period expires, the first media is removed from the frame, and the second media is inserted into the frame.

14. The system of claim 4, further comprising:
a frame retaining the filter media;
a first charging pin on the frame;
a base including a second charging pin, the second charging pin complementary the first charging pin; and
wherein the frame is releasably secured to the base.

15. The system of claim 4, further comprising:
a high voltage power source;
a corona wire electrically connected to the power source to charge the corona wire one of a positive charge and a negative charge; and
wherein the conductive array affixed on the high air flow filter media is electrically connected to the power source and has a charge opposite of the corona wire.

16. The system of claim 4, wherein the high air flow filter media comprises an anti-microbial agent.

17. A method of operating a charged filtrations system comprising the steps of:
providing a high air flow filter media having an upstream and downstream surface, the filter media further including a conductive electrode array to one of the upstream and downstream surface;
inserting the high air flow filter media into the downstream end of a frame having a corona wire in a housing, the corona wire electrically connected to a power source;
moving air from upstream to downstream around the corona wire and through the filter media; and
removing the filter media after the expiration of set period.

18. The method of claim 17, wherein the set period is equal to a length time a person occupies a hospital room.

19. The method of claim 17, further comprising the steps of:
inserting a second filter similar to the first filter media, prior to the beginning of a second set period.

20. The method of claim 17, wherein prior to the step of providing a filter media comprises the steps of:
fixedly attaching the frame to a portion of a surrounding room in which the frame is disposed within; and
inserting the housing into the frame at the upstream end.
